(19) United States
(12) Patent Application Publication
(10) Pub. No.: US 2006/0002265 A1
(43) Pub. Date: Jan. 5, 2006

(54) Optical disc device

(75) Inventor: Satoru Kojima, Kawaguchi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/156,551

(22) Filed: Jun. 21, 2005

(30) Foreign Application Priority Data
Jun. 30, 2004 (JP) 2004-193768

(51) Int. Cl. G11B 7/00

(52) U.S. Cl. 369/47.31; 369/47.1; 369/59.1; 369/44.13

(57) ABSTRACT

To achieve accurate sync detection and physical address detection which is robust against disturbance such as noise or the like, four wobbles may be added to form one input to suppress the influence of disturbance such as noise or the like. Using an input bit which is robust against disturbance, a count value of a non-modulated field located before a SYNC pattern is used to generate a gate signal for sync signal detection. In this way, any detection error of a sync signal is prevented.

### CROSS-REFERENCE TO RELATED APPLICATIONS

This application is based upon and claims the benefit of priority from prior Japanese Patent Application No. 2004-193768, filed Jun. 30, 2004, the entire contents of which are incorporated herein by reference.

### BACKGROUND OF THE INVENTION

1. Field of the Invention

The present invention relates to an optical disc device and, more particularly, to improvement of sync signal detection and physical address detection in an optical disc device.

2. Description of the Related Art

In recent years, optical discs such as a DVD (Digital Versatile Disc) and the like have prevailed as digital recording media, and high reliability is required of optical disc devices that play them back. In such optical discs, a storage area is formed on spiral tracks, and its address information includes track numbers. Upon a fastforwarding/rewinding process or the like in a playback mode, an optical pickup is fed by a motor drive, and an objective lens is then tilted as needed by an actuator, thus making fine adjustment for each track. In a track jump process, whether or not a track number is a desired one is checked upon determining if the optical pickup accurately jumps to a target address. Jpn. Pat. Appln. KOKAI Publication No. 2002-109756 discloses an optical disc device which performs a jump process in response to a track jump process command, and determines based on address information whether or not the jump process has succeeded. If it is determined that the target track has not been reached, the jump process is repeated.

The standard itself of the DVD has advanced, and Hi-Vision compatible next-generation DVD standard is expected to be laid down soon. Since the next generation DVD standard has a higher recording density than the current-generation DVD standard, the C/N ratio of a playback signal is prone to lower, and a sync signal and address information are readily influenced by disturbance such as noise and the like upon extracting them from the playback signal. Jpn. Pat. Appln. KOKAI Publication No. 2003-187457 shifts a 1-bit input signal by a shift register to verify it with a pattern, thus obtaining a sync signal.

In Jpn. Pat. Appln. KOKAI Publication No. 2002-109756, whether or not a jump process can be made is checked based on address information after jump. However, with this method, a physical address is detected after one track jump. Hence, whether or not the physical address of the neighboring track after one track jump is detected cannot be determined, and the physical address of another track may be detected. Therefore, whether or not the physical address is correct cannot be determined by detecting and comparing two physical addresses after one track jump, and reliable physical address detection takes much time.

Since Jpn. Pat. Appln. KOKAI Publication No. 2003-187457 adopts a 1-bit input signal, it is easily influenced by disturbance such as noise and the like. Furthermore, in case of the next-generation standard, a SYNC pattern is similar to a physical address pattern, and for example, the physical address is erroneously detected as SYNC, thus often causing operation errors.

More specifically, in the circuit arrangement of Jpn. Pat. Appln. KOKAI Publication No. 2003-187457, if there is no disturbance such as noise or the like, a portion unique to the SYNC pattern of a wobble signal at a predetermined SYNC pattern position can be accurately recognized, and a sync signal indicating SYNC detection at the predetermined position is output. By contrast, if a signal of an address pattern at a predetermined address position is disturbed by disturbance such as noise or the like, SYNC may be erroneously detected. When SYNC is erroneously detected in this way, a signal that follows the erroneously detected SYNC is recognized as a physical address, and a correct physical address cannot be acquired. Hence, a correct position on a disc cannot be detected, thus causing operation errors.

### BRIEF SUMMARY OF THE INVENTION

In a circuit/method for sync signal detection or physical address detection according to an embodiment of the present invention, an input is formed by a plurality of bits (e.g., one input is formed by four wobbles), and level detection and state detection of an edge change point are made to suppress the influence of disturbance such as noise or the like. Furthermore, a non-modulated field (Unity) present before SYNC and physical address field is used in SYNC detection, thus preventing detection errors of SYNC.

According to an aspect of the present invention, accurate SYNC detection/physical address detection which can assure highest detection efficiency and is robust against disturbance such as noise or the like can be attained.

### BRIEF DESCRIPTION OF THE SEVERAL VIEWS OF THE DRAWING

FIG. 1 is a block diagram showing an example of the arrangement of an optical disc device according to an embodiment of the present invention;

FIG. 2 is an explanatory view showing an example of the arrangement of a pickup of the optical disc device according to the embodiment of the present invention;

FIG. 3 is a block diagram showing an example of the arrangement of a wobble PLL unit/address detection unit according to the embodiment of the present invention;

FIG. 4 is a waveform chart showing an example of a signal waveform upon reading a signal in the wobble PLL unit/address detection unit according to the embodiment of the present invention;

FIG. 5 is an explanatory view showing an example of the peripheral layout of recording tracks of an optical disc to be handled by the optical disc device according to the embodiment of the present invention;

FIG. 6 is an explanatory view showing an example of the physical address format (next-generation DVD physical address format) of a wobble signal of an optical disc to be handled by the optical disc device according to the embodiment of the present invention;

FIG. 7 is a block diagram showing an example of the circuit arrangement of a sync signal detection circuit according to the embodiment of the present invention;

FIG. 8 is a view for explaining the sync detection timings in the embodiment of the present invention;

FIG. 9 is a view for explaining an example of the contents (an example of a sequence of a unity field, sync pattern, and address field) of a wobble signal on the optical disc according to the embodiment of the present invention;

FIG. 10 is a view for explaining the sync detection timings (example 1) in another embodiment of the present invention;

FIG. 11 is a view for explaining the sync detection timings (example 2) in another embodiment of the present invention;

FIG. 12 is a block diagram showing an example of the circuit arrangement of an address detection unit according to the embodiment of the present invention; and

FIG. 13 is a view for explaining the address detection timings in the embodiment of the present invention.

### DETAILED DESCRIPTION OF THE INVENTION

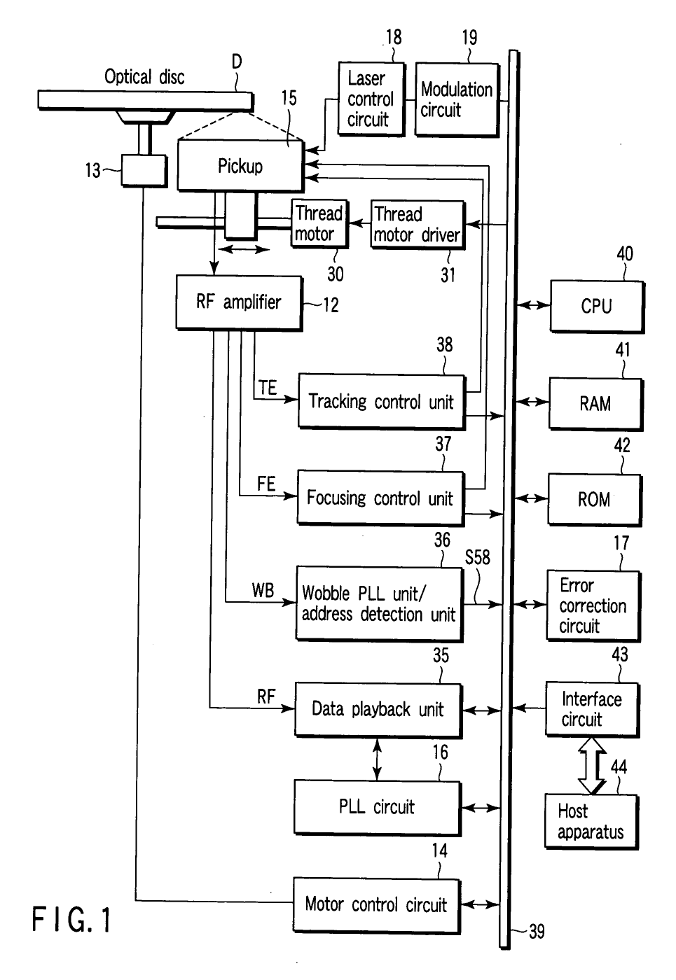

Embodiments of the present invention will be described hereinafter with reference to the accompany-ing drawings. FIG. 1 is a block diagram for explaining an example of the arrangement of an optical disc device according to the embodiment of the present invention.

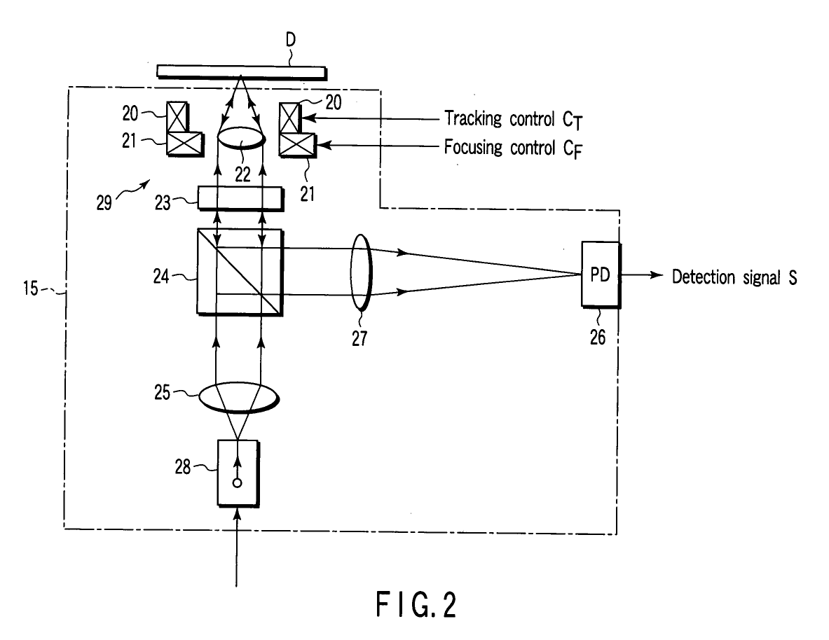

FIG. 2 is a view for explaining an example of the arrangement of a pickup of the optical disc device according to the embodiment of the present invention.

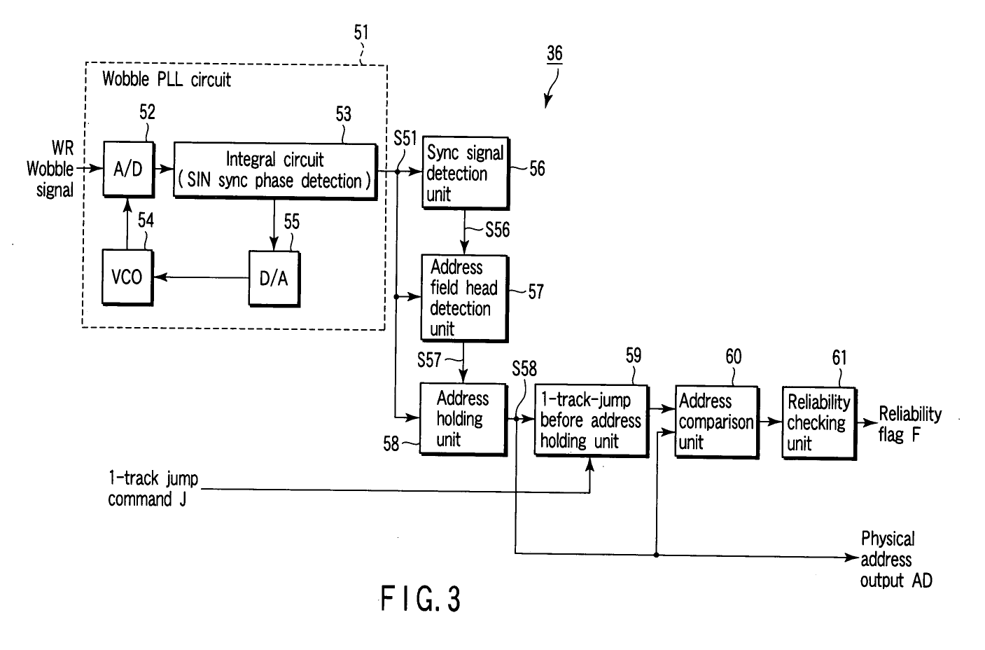

FIG. 3 is a block diagram for explaining an example of the arrangement of a wobble PLL unit/address detection unit of the optical disc device according to the embodiment of the present invention.

An optical disc device according to the embodiment of the present invention has the arrangement shown in FIGS. 1 and 2. Note that optical disc D is an optical disc on which user data is recordable (or rewritable) or a read-only optical disc. In this embodiment, optical disc D will be explained as a recordable (or rewritable) optical disc. As a recordable or rewritable optical disc, a next-generation DVD-RAM, DVD-RW, DVD-R, and the like using a blue laser with a wavelength of about 405 nm (or a current-generation DVD-RAM, DVD-RW, DVD-R, and the like using a laser with a wavelength of 650 nm) are known.

Land and groove tracks are spirally formed on the surface of optical disc D, which is rotated by spindle motor 13. Pickup 15 records/plays back information on/from optical disc D. Pickup 15 is coupled to thread motor 30 via gears. Thread motor 30 is controlled by thread motor driver 31 connected to data bus 39. A permanent magnet (not shown) is provided to a stationary part of thread motor 30, and a drive coil (not shown) is energized, thus moving pickup 15 in the radial direction of optical disc D.

Pickup 15 has objective lens 22, as shown in FIG. 2. Objective lens 22 is movable in the focusing direction (the optical axis direction of the lens) by driving drive coil 21. Also, objective lens 22 is movable in the tracking direction (a direction perpendicular to the optical axis of the lens) by driving drive coil 20. By moving a beam spot of a laser beam, a track jump operation can be made.

Modulation circuit 19 provides EFM data by applying 8-14 modulation (EFM) to user data which is supplied from host apparatus 44 via interface circuit 43 upon recording information. Laser control circuit 18 provides a write signal to semiconductor laser diode 28 on the basis of EFM data supplied from modulation circuit 19 upon recording information (upon mark formation). Laser control circuit 18 provides a read signal smaller than a write signal to semiconductor laser diode 28 upon reading information.

Semiconductor laser diode 28 generates a laser beam in accordance with a signal supplied from laser control circuit 18. The laser beam emitted by semiconductor laser diode 28 strikes optical disc D via collimator lens 25, half prism 24, and objective lens 22. Light reflected by optical disc D is guided to photodetector 26 via objective lens 22, half prism 24, and focusing lens 27.

Photodetector 26 is made up of four-split photodetection cells, which supply signals A, B, C, and D to RF amplifier 12. RF amplifier 12 supplies tracking error signal TE corresponding to (A+D)−(B+C) to tracking control unit 38, and focusing error signal FE corresponding to (A+C)−(B+D) to focusing control unit 37. Furthermore, RF amplifier 12 supplies wobble signal WB corresponding to (A+D)−(B+C) to wobble PLL unit/address detection unit 36 and an RF signal corresponding to (A+D)+(B+C) to data playback unit 35.

On the other hand, an output signal from focusing control unit 37 is supplied to focusing drive coil 21. With this signal, control is made to always bring the laser beam in just focus on a recording film of optical disc D. Tracking control unit 38 generates a tracking drive signal in accordance with tracking error signal TE, and supplies it to drive coil 20 in the tracking direction.

As a result of the focusing control and tracking control, sum signal RF of output signals from the photodetection cells of photodetector 26 reflects a change in reflectance from pits and the like formed on the tracks of optical disc D in correspondence with recording information. This signal is supplied to data playback unit 35.

Data playback unit 35 plays back recording data on the basis of reproduction clocks from PLL circuit 16. Data playback circuit 35 has a function of measuring the amplitude of signal RF, and the measured value is read out by CPU 40.

While objective lens 22 is controlled by tracking control unit 38, thread motor 30 is controlled to locate objective lens 22 at an optimal position of the optical disc, thus controlling pickup 15.

Motor control circuit 14, laser control circuit 18, PLL circuit 16, data playback unit 35, focusing control unit 37, tracking control unit 38, and the like can be formed in a single LSI chip as a servo control circuit. These circuits are controlled by CPU 40 via bus 39. CPU 40 systematically controls this optical disc recording/playback device in accordance with operation commands supplied from host apparatus 44 via interface circuit 43. CPU 40 uses RAM 41 as a work area, and performs predetermined operations in accordance with a program which is recorded on ROM 42 and includes the present invention.

FIG. 3 shows a practical example of the circuit arrangement (including an arrangement for generating a physical address based on a wobble signal) corresponding to wobble PLL unit/address detection unit 36 in FIG. 1. Principal part of this arrangement is roughly divided into wobble PLL circuit 51, sync signal detection unit (SYNC detection circuit) 56, and address field head detection unit (address detection circuit) 57. Wobble PLL circuit 51 has A/D circuit 52 which converts wobble signal WB into a digital signal, integral circuit (SIN sync phase detection circuit) 53 which integrates the output from A/D circuit 52, D/A circuit 55 which converts the output from integral circuit 53 into an analog signal, and VCO circuit 54 which supplies an oscillation signal, whose period is controlled based on the signal level from D/A circuit 55, to A/D circuit 52.

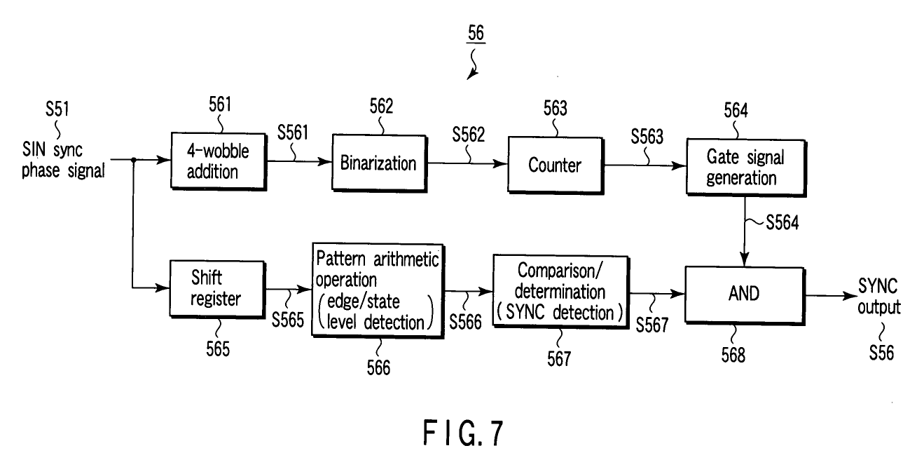

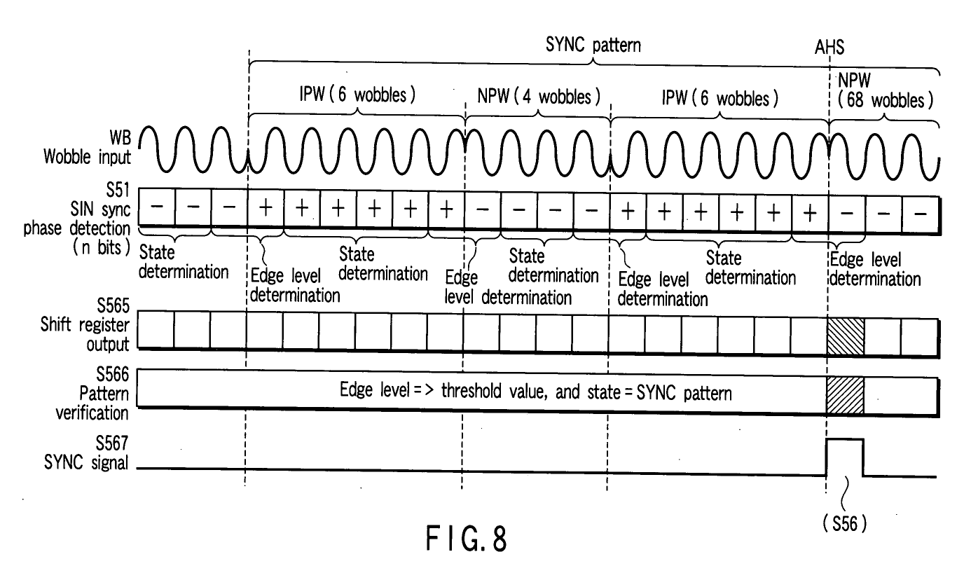

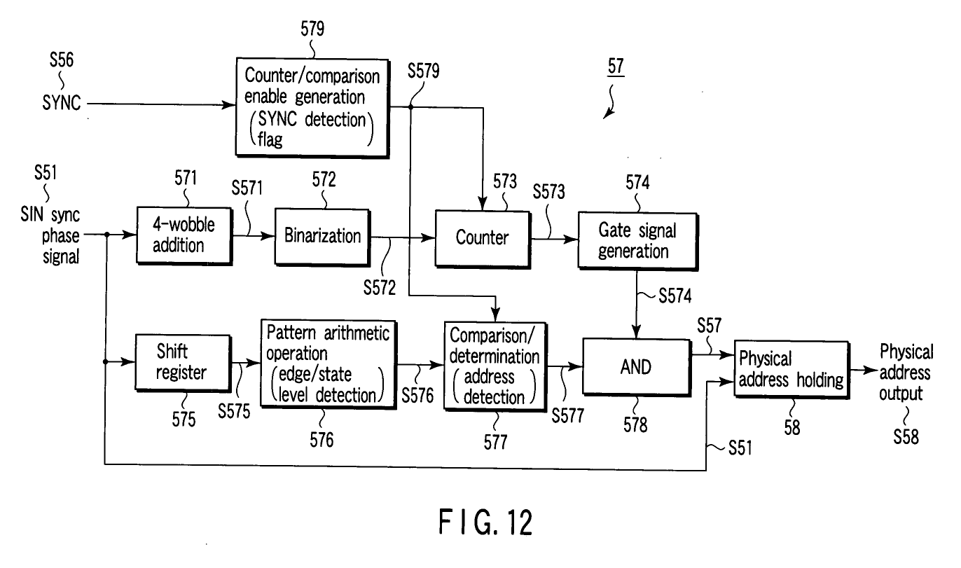

Wobble PLL circuit 51 integrates wobble input signal WB and SIN waves, and generates SIN sync phase detection circuit signal S51 shown in, e.g., FIG. 8, 10, or 11 to be described later. In SIN sync phase detection circuit signal S51, an inverted phase wobble part (IPW part) is output as a “+” value, and a normal phase wobble part (NWP part) is output as a “−” value. From this signal S51, a SYNC pattern and address pattern are detected. The arrangement in FIG. 3 is especially characterized by circuit blocks 56 and 57, and details of these circuit blocks will be described later using FIGS. 7, 12, and the like.

Wobble PLL unit/address detection unit 36 shown in FIG. 3 includes address holding unit 58, one-track-jump before address holding unit 59, address comparison unit 60, and reliability checking unit 61 in addition to wobble PLL circuit 51, sync signal detection unit 56, and address field head detection unit 57. With this arrangement, wobble PLL unit/address detection unit 36 checks reliability upon track jump on the basis of wobble signal WB, and can output reliability flag F onto data bus 39 together with physical address output AD.

Circuit blocks 51 to 61 in FIG. 3 (or at least 56 to 58 in FIGS. 7 and 12) can comprise discrete electronic parts but they desirably form an IC (controller LSI) in mass production.

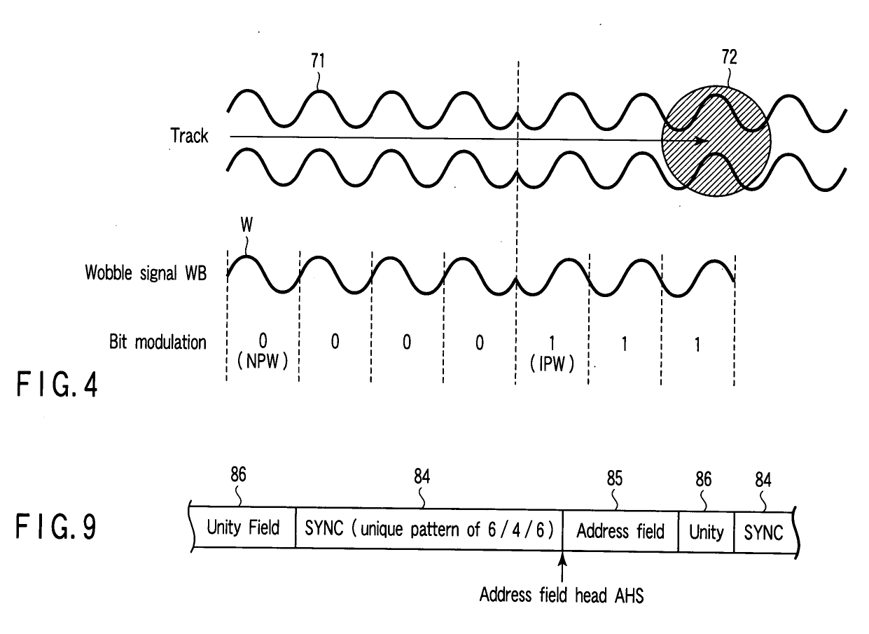

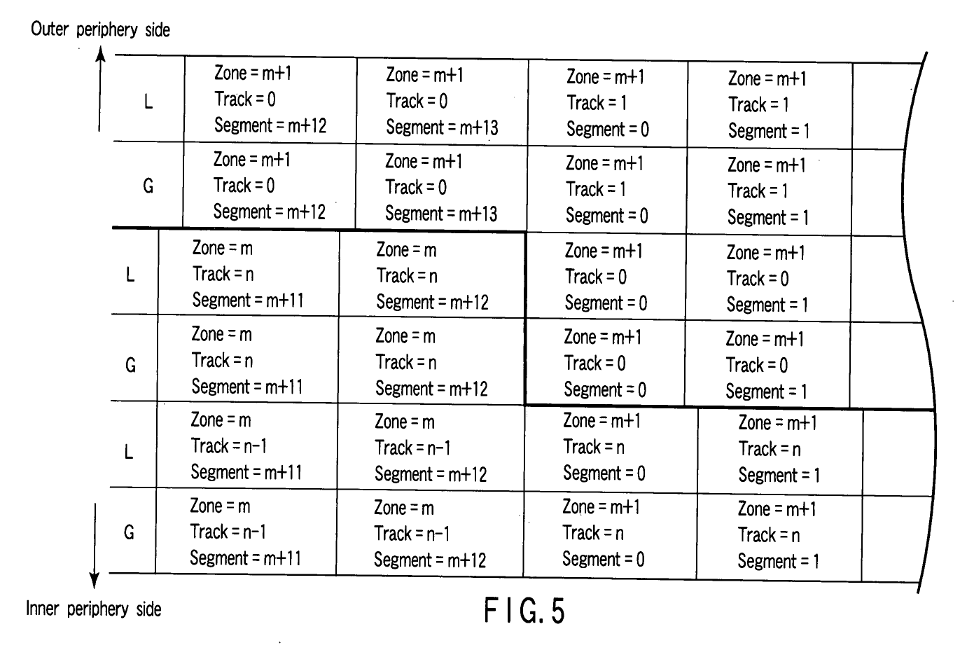

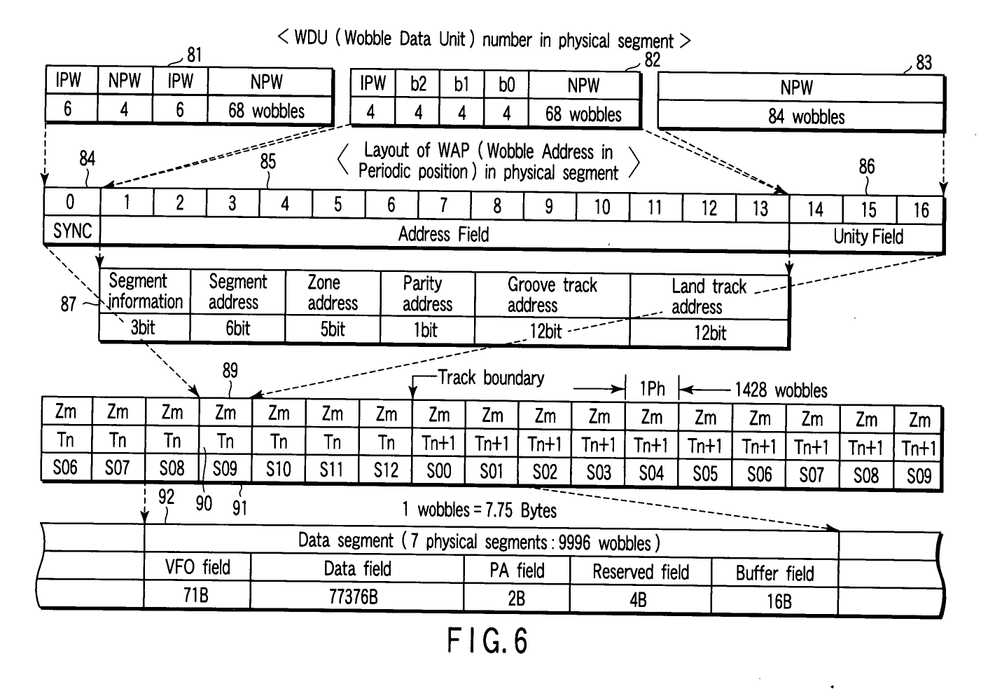

The optical disc device which has the aforementioned arrangement and performs playback and recording processes can perform a track jump process as follows, and can confirm the reliability of this track jump process. FIG. 4 is a waveform chart for explain-ing a signal waveform example upon reading a signal in the wobble PLL unit/address detection unit of the optical disc device according to the embodiment of the present invention. FIG. 5 is a view for explaining an example of the peripheral layout of recording tracks of an optical disc handled by the optical disc device according to the embodiment of the present invention. FIG. 6 is a view for explaining an example of the physical address format (next-generation DVD physical address format) of a wobble signal of an optical disc handled by the optical disc device according to the embodiment of the present invention.

FIG. 4 exemplifies the relationship of respective signals when recording tracks are formed by wobble modulation as the addressing method of optical disc (recording medium) D. Digital data is played back from (or digital data is recorded on) a zigzag recording track, and recorded data is recorded at a designated position. Physical address information which deter-mines that position is obtained by reading out and demodulating wobble signal WB corresponding to wobbles 71 of the recording track. FIG. 4 exemplifies read beam 72 on the track, detected wobble signal WB, and a modulation rule when information is embedded by wobble modulation. In this case, address information is recorded using a sine wave (normal phase wobble: NPW) of wobble signal WB as “0” and a cosine wave (inverted phase wobble: IPW) as “1”.

FIG. 5 exemplifies the layout of physical address information for a structure in which the recording tracks of an optical disc recording medium are commonly used for lands/grooves. In this example, since addressing based on wobble modulation is made on groove tracks, correct addressing must be attained for recording/playback for land tracks. Hence, a structure called a zone method is adopted. Optical disc D is divided into a plurality of zones in the radial direction, segment packets with a constant recording size are formed in each zone, and “zone numbers”, “track numbers”, and “segment numbers” as physical address information are embedded in these packets by wobble modulation of groove tracks. When a zone changes, the division angle is changed to form segments to have substantially the same recording density, thus optimizing the recording density. With the configuration shown in FIG. 5, even in the land/groove method, address information values of groove wobbles assume the same value between neighboring tracks except for track numbers, and physical address information can be read out even from a land track. Since land and groove track numbers are allocated so as to obtain information from both a land and groove, no problem is posed.

FIG. 6 exemplifies the data structure of an address as the overall relationship. Physical address information is embedded in groups 84 to 86 called WAPs (Wobble Address in Periodic position) each of which is formed of 17 WDUs (Wobble Data Units) (81 to 83). Since track wobbles are formed by coupling WAPs, a period determined by WAP becomes a period where physical address data is embedded.

Physical address data 85 is formed of 39 bits. Note that information bit group 87 of “segment information”, “segment address”, “zone address”, “parity address”, “groove address”, and “land address” is divided in groups of 3 bits and is distributed to respective WDUs, which are embedded by a modulation process. In this way, zone numbers 89, track numbers 90, and segment numbers 91 are stored.

WDU 82 embedded with address information forms address information by 3 bits, and 1 bit corresponds to four wobbles. Hence, first four wobbles of each WDU adopt an IPW configuration to facilitate head identification of the WDU. As a result, 68 wobbles after embedding of address information of each WDU are specified as NPW.

Since overall address data includes 39 bits, 13 WDUs 82 are required. Sync signal 84 of a WAP is allocated in a WDU on the head side, and three units on the rear side are formed of non-modulated units (unity fields) 86. Information data is recorded on recording tracks in which physical addresses are embedded by such track wobble modulation. As recording data in this case, a 71-byte VFO field (a constant frequency signal that allows easy generation of data demodulation channel clocks) is recorded on the head side of 77376-byte data, and a “PA field”, “reserved field”, and “buffer field” of a total of 22 bytes, which are required to perform a data block connection process, are recorded on the rear side of the data. A total of 77469 bytes are recorded in seven physical segments (corresponding to 9996 wobbles). According to such rules, information data is recorded at a location designated using “physical segment” address data. As a result, it is important to accurately read out address data of the physical segment.

Physical addresses are recorded on optical disc D by modulating track wobbles with the above configuration. When a physical address is read out from wobbles on such optical disc D, a sync signal is detected from wobble signal WB, a timing signal is generated according to this sync signal, and address information is extracted from the wobble signal in accordance with this timing signal, thus demodulating and acquiring the address information.

An example of the acquisition timing of address information based on wobble signal WB will be explained below. When one track jump is made from current track point P1 to neighboring track point P2, physical address detection starts from track point P2. When track point P2 falls outside a physical address field, physical address detection starts from track point P3. Furthermore, the physical address of track point P4 is detected to confirm the reliability of the physical address, and is compared with track point P3, thereby confirming if the target point of track jump is correct.

In the next-generation DVD physical address format of the wobble signal of the optical disc, a physical address is formed of “zone number”, “track number”, and “segment number”, and one physical address is formed by one WAP, as shown in FIG. 6. Since neighboring track numbers in a single zone have a Hamming distance=1, the reliability of the physical address upon one track jump can be confirmed.

Address information is acquired by address detection unit 36 in FIG. 3. Initially, each physical address of current recording track point PA is always held in address holding unit 58 using a register or the like. Next, when track jump is required after pickup 15 is moved by thread motor 30 or the like in response to a fastforwarding or rewinding operation of the user, CPU 40 or the like supplies position track jump command J from one-track-jump before address holding unit 59 of address detection unit 36, thus holding an address before jump, which is held by the address holding unit 58. At the same time, when CPU 40 or the like supplies position tracking jump command J to tracking control unit 38, tracking control unit 38 supplies tracking control signal CTR to drive coil 20. As a result, objective lens 22 moves to make track jump of a beam spot from track point PA to track point PB.

After that, address comparison unit 60 compares the address one track before from one-track-jump before address holding unit 59 with that after one track jump from address holding unit 58, thus comparing track numbers. At this time, upon movement of the beam spot toward the outer periphery of optical disc D, it is checked if the track number included in the address information increases in correspondence with movement. Upon movement of the beam spot toward the inner periphery of optical disc D, it is checked if the track number included in the address information decreases in correspondence with movement. The checking result of address comparison unit 60 is supplied to reliability checking unit 61. When reliability checking unit 61 confirms a change in track number by one track, it sets reliability flag F to be, e.g., “1”, and supplies it to CPU 40 or tracking control unit 38. As a result, when jump has succeeded, the jump process ends; otherwise, another track jump process is executed.

More specifically, if track point PB after track jump is a physical address field, it can determine that track jump is attained normally by detecting address information at track point PB. On the other hand, if track point PB after track jump falls outside a physical address field, it can determine that track jump is attained normally by detecting address information at track point PC.

According to the address information acquisition method, the track jump reliability can be confirmed more quickly, and it can be confirmed if one track jump position is correct.

FIG. 7 is a block diagram for explaining an example of the circuit arrangement of sync signal detection unit (SYNC detection circuit) 56 according to the embodiment of the present invention. The block arrangement of SYNC detection circuit 56 is roughly divided into a SYNC detection unit (shift register 566+pattern arithmetic operation (state+edge level calculation) unit 566+comparison/determination (SYNC detection) unit 567) and a non-modulated field detection unit (4-wobble addition 561+binarization 562+counter 563+gate signal generation 564).

The SYNC detection unit (565 to 567) is a circuit that detects six IPW wobbles+four NPW wobbles+six IPW wobbles (unique pattern portion) as a SYNC pattern unique portion of 84 wobble signals at a predetermined SYNC pattern position (WAP “0”-th position in FIG. 6). Initially, shift register 565 executes a shift process of SIN sync phase detection signal S51. The processing result is input to pattern arithmetic operation unit 566, which makes a difference calculation of a sign change point (IPW→NPW/NPW→IPW: edge detection) of the signal that has undergone the shift process, and state stability detection (equal sign) of the state by comparing the sign of the signal other than the edge change point. Comparison/determination unit 567 determines that a sync signal is detected when it is determined that the edge detection value of pattern arithmetic operation unit 566 is equal to or larger than a threshold value, and the state matches SYNC, and outputs signal S567.

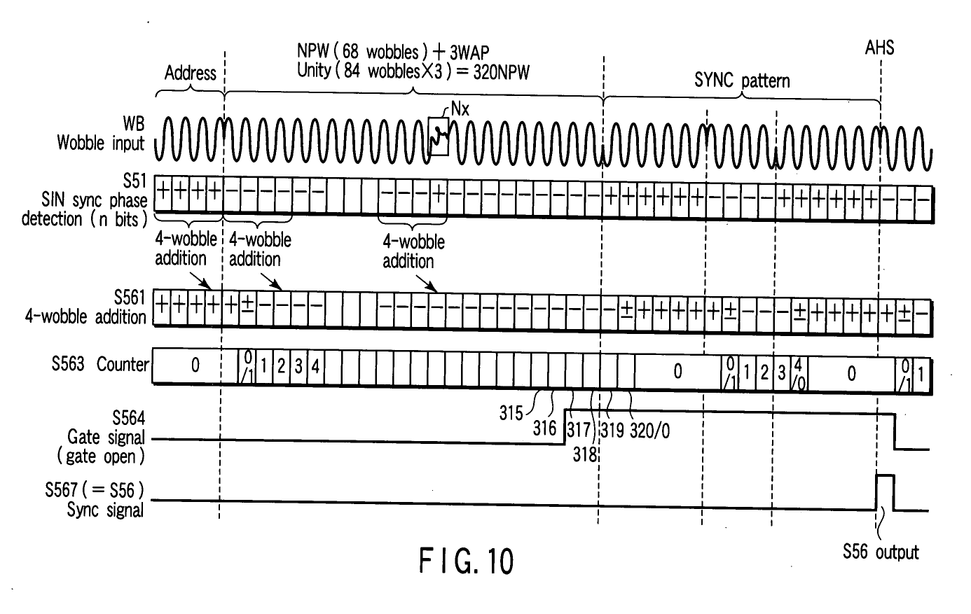

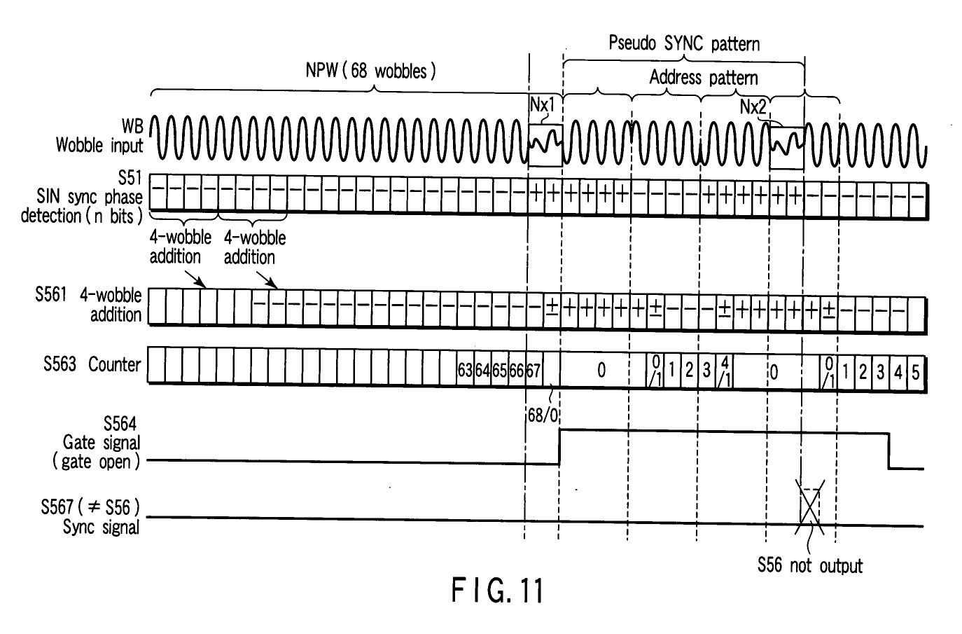

On the other hand, the non-modulated field detection unit (561 to 564) is a circuit for generating gate signal S564 shown in FIGS. 10 and 11. Initially, 4-wobble addition as a maximum change unit common to the SYNC and physical address is made. Four wobbles form a modulation sign bit clock unit common to the SYNC and physical address signals, and since the state of that unit changes for respective four wobbles, the unit can assure a highest detection efficiency.

When addition is made for four respective wobbles, even when one of these wobbles changes due to noise Nx or the like, a normal result of the remaining three wobbles dominates in the addition result for four wobbles, thus preventing a detection error. (FIG. 10 exemplifies a case wherein the bit contents of 4-wobble compatible signal S51 which should be “−−−−” have changed to “−−−+” as a result of a wobble waveform abnormality due to noise Nx, but it is normally detected as “−” by a kind of majority rule as a result of 4-wobble addition.) Note that the 4-wobble addition result becomes indefinite in the contents for four wobbles which include the same numbers of pluses and minuses like “++−−”. However, such portion has low probability of occurrence except for a portion where a wobble waveform changes from IPW to NPW or vice versa, and hence detection is hardly influenced by noise as a whole. As one of methods of avoiding this indefinite addition result, odd wobble addition (e.g., wobble 3-wobble or 5-wobble addition) may be adopted.

According to the arrangement of FIG. 7, even when a detection error (Nx portion) for one wobble signal has occurred, as shown in FIG. 10, a detection error in a non-modulated field as continuous NPW is prevented, and SYNC detection precision improves. A binary signal of the 4-wobble addition result (“−”signs of S561 in a non-modulated field (320-NPW unity field) in FIG. 10) is counted up by counter 563 (in case of a “+” sign, since a signal falls outside the non-modulated field, counter 563 is cleared). A non-modulated field (Unity) present before a SYNC field includes 320 wobbles=three “14th to 16th” WAPs (unity) (84 wobbles×3)+68 wobbles of the address of “13th” WAP in FIG. 6. In the example of FIG. 10, gate signal generation unit 564 is turned on (to generate gate signal S564) when the count value=316 of counter 563.

Output signal S567 from SYNC detection unit 567 is extracted as SYNC output S56 while this gate signal S564 is generated. In this way, even when signal S567 is generated during a non-generation period of gate signal S564 (due to, e.g., generation of pseudo SYNC pattern shown in FIG. 11), this wrong signal S567 can be prevented from being extracted as SYNC output S56.

The circuit arrangement in FIG. 7 includes a sync signal detection circuit which comprises a first circuit system (561 to 564 in FIG. 7) that receives a sync phase signal (S51) as repetition of sequences of a non-modulated field (86), sync field (84), and address field (85), and generates a gate signal (S564) corresponding to the position of the sync field (84) from the non-modulated field (86) in the sync phase signal (S51), a second circuit system (565 to 567 in FIG. 7) that generates a sync signal (S567) indicating the head (AHS) of the address field (85) from the sync field (84) in the sync phase signal (S51), and a third circuit system (568 in FIG. 7) that provides a sync output (S56) by allowing the sync signal (S567) to pass while the gate signal (S564) is generated.

FIG. 8 is a view for explaining the sync detection timings in the embodiment of the present invention. FIG. 9 is a view for explaining an example of the contents (an example of a sequence of a unity field, sync pattern, and address field) of a wobble signal on the optical disc according to the embodiment of the present invention.

A signal input to sync signal detection unit 56 has contents as repetition of a sequence of Unity 86, SYNC 84, and address field 85, as shown in FIG. 9. In order to detect head AHS of address field 85 from such signal, sync signal S567 (S56) is generated based on a unique pattern of SYNC 84.

That is, as shown in FIG. 8, the SYNC pattern has a unique pattern formed of six IPW wobbles (the state checking result of SIN sync phase detection is “+”), four NPW wobbles (the state checking result of SIN sync phase detection is “−”), and six IPW wobbles (the state checking result of SIN sync phase detection is “+”) The divisions of the six IPW wobbles, four NPW wobbles, and six IPW wobbles can be determined based on a phase change of wobble input WB or edge level change of SIN sync phase detection signal S51. When this edge level has a value equal to or larger than a predetermined threshold value and the detected pattern matches the SYNC unique pattern (6/4/6), pattern verification (pattern arithmetic operation) result S566 is determined as “SYNC pattern”, and sync signal S567 (S56) is output.

FIG. 10 is a view for explaining the sync detection timings (example 1) in another embodiment of the present invention. In this example, since count signal (“−”) S561 is generated by adding (or integrating) four wobbles from SIN sync phase detection signal S51 corresponding to four wobbles, even when one of four wobbles is influenced by noise, the influence of noise can be removed in view of four waves as a whole. By counting count signals (“−”) S561 free from the influence of noise for the unity field (“316” counts in this case), the location where the SYNC pattern is present is detected, thus generating gate signal S564. The signal width of this gate signal S564 is slightly broader than that of the SYNC pattern, so that the SYNC pattern (at least its end position) falls within the signal width of gate signal S564. Sync signal S567 is generated at the end of the SYNC pattern. This signal S567 passes through AND gate 568 while gate signal S564 is generated, thus obtaining regular sync signal S56.

In this manner, signal S567 which is erroneously generated while no gate signal S564 is generated can be prevented from being output as sync signal S56 from AND gate 568.

FIG. 11 exemplifies a case wherein signal S567 which is erroneously generated while no gate signal S564 is generated is blocked by the AND gate and is not output as sync signal S56. That is, even when an address pattern is erroneously detected as the SYNC pattern due to disturbance (Nx1, Nx2) such as noise or the like (pseudo SYNC pattern is detected), the count value of the non-modulated field (unity field) does not reach a predetermined value (“316” in the example of FIG. 10) and no gate signal S564 is generated at that time. Hence, signal S567 generated based on the pseudo SYNC pattern is blocked by AND gate 568. In this way, since erroneously generated signal S567 can be prevented from being output as sync signal S56 from AND gate 568, any SYNC detection error can be avoided.

FIG. 12 is a block diagram showing an example of physical address detection as a modification of SYNC detection using a non-modulated field. As shown in FIG. 6 or 9, since the physical address (85) starts immediately after the SYNC pattern (84), a correct physical address can be detected after SYNC detection. Hence, a “flag indicating that SYNC detection is made” is set based on SYNC output S56 output from sync signal detection unit (AND gate 568) 56 in FIG. 7. When this “flag indicating that SYNC detection is made” is set, physical address detection is made. As a non-modulated field used to capture the location of head AHA of address field 85, 68 NPW wobbles after the SYNC pattern (six IPW wobbles+four NPW wobbles+six IPW wobbles denoted by 81 in FIG. 6) are used, as shown in FIG. 6.

That is, in the circuit arrangement shown in FIG. 12, SYNC output S56 is input to counter/comparison enable generation circuit 579 to set flag “indicating that SYNC detection is made” S579 (=“1”). When this flag is active (flag S579=“1”), binary signals S572 of 4-wobble addition results S571 of SIN sync phase signal S51 are counted by counter 573. If this count value S573 reaches, e.g., 65, gate signal generation circuit 574 generates gate signal S574.

On the other hand, as in the circuit arrangement in FIG. 7, SIN sync phase signal S51 is processed by shift register 575 and pattern arithmetic operation unit 576. The difference calculation of a sign change point (IPW→NPW/NPW→IPW: edge detection) of the signal that has undergone the shift process, and state stability detection (equal sign) of the state by comparing the sign of the signal other than the edge change point are performed. Comparison/determination unit 577 determines that address head AHA is detected when it is determined that the edge detection value of pattern arithmetic operation unit 576 is equal to or larger than a threshold value, and the state matches the address head (e.g., SIN sync phase detection signal S51=“++++”) while flag S579=“1”, thus outputting signal S577.

Signal S577 output in this way passes through AND gate 578 during a generation period of gate signal S574, and is input to physical address holding unit 58 as signal S57 used to capture address field head position AHA (when signal S577 is generated during a non-generation period of gate signal S574, this signal S577 is blocked by AND gate 578 since it is generated due to a detection error). Upon reception of signal S57, physical address holding unit 58 fetches and holds SIN sync phase signal S51 immediately after reception as physical address information. The physical address information (3-bit address bits 2 to 0) held in this way is used as physical address output S58.

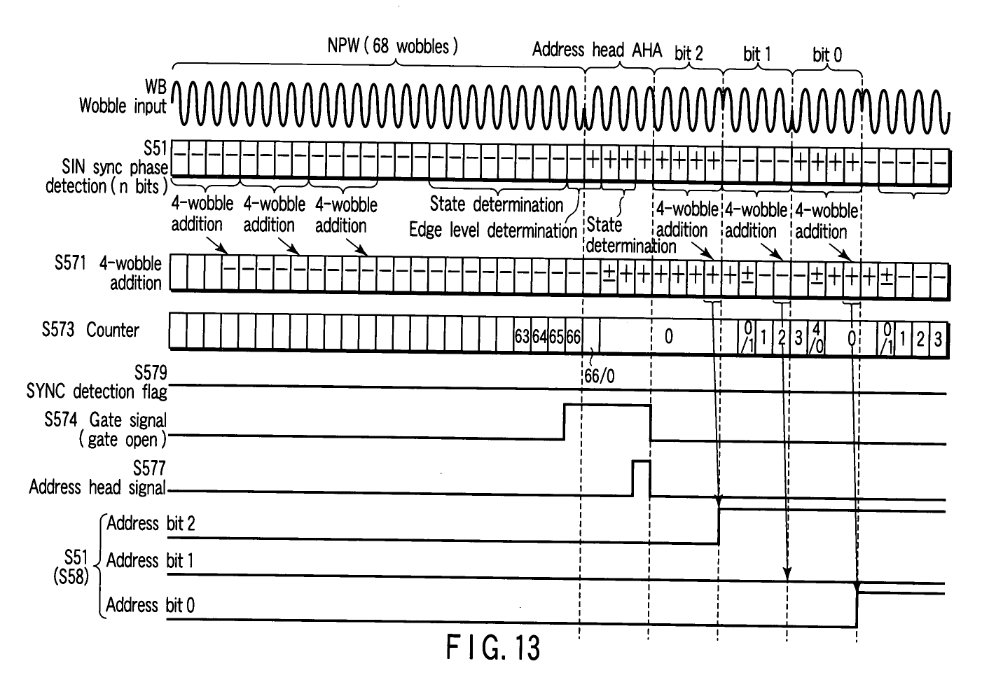

FIG. 13 exemplifies the address detection timings by the circuit arrangement shown in FIG. 12 above. In this example; gate signal generation circuit 574 is turned on in response to the count value=65 of counter 573 in FIG. 12 so as to enable AND gate 578. When address head AHA can be successfully detected, physical address holding unit 58 latches the signs of 4-wobble addition values of bits 2, 1, and 0 of next SIN sync phase signal S51 as an address, thus acquiring address output S58.

The arrangement shown in FIG. 12 comprises an address detection circuit system (575 to 577, 579 in FIG. 12) which outputs an address head signal (S577) indicating the head (AHA) of an address field (85) in a sync phase signal (S51) on the basis of a sync output 9S56) provided from 568 in FIG. 7, and a physical address holding circuit (58) which holds and outputs the contents (address bits 0 to 2 in FIG. 13; or S51 in the address field) of the address field (85) that follows the address head signal (S577) as information (S58) indicating the physical address of this address field (85).

### SUMMARY OF EFFECTS OF EMBODIMENT

In detection of a non-modulated field according to the embodiment of the present invention, binary (sign) signals of 4-wobble sum values as modulation sign bit clock units common to the SYNC and physical address signals are counted for position detection. In this way, SYNC detection can be made using that non-modulated field by a simple circuit which has a highest detection efficiency and is robust against disturbance such as noise or the like. Hence, SYNC detection errors can be prevented, and highly reliable SYNC detection can be made.

Since physical address detection is made after the highly reliable SYNC detection, highly reliable physical address detection can be attained.

A SYNC detection error leads to a detection error of the physical address written immediately after SYNC. For this reason, when a SYNC detection error has occurred, the correct location (address) on the disc cannot be detected, and data cannot be normally acquired or written. Therefore, SYNC must be detected at a correct location. The embodiment of the present invention is very effective since it can attain accurate SYNC detection/physical address detection robust against disturbance such as noise or the like.

Note that the present invention is not limited to the aforementioned embodiments, and various modifications may be made on the basis of techniques available at that time without departing from the scope of the invention when it is practiced at present or in the future. The respective embodiments may be combined as needed as long as possible, and combined effects can be obtained in such case. Furthermore, the embodiments include inventions of various stages, and various inventions can be extracted by appropriately combining a plurality of required constituent elements disclosed in this application. For example, even when some required constituent elements are deleted from all the required constituent elements disclosed in the embodiments, an arrangement from which those required constituent elements are deleted can be extracted as an invention.

What is claimed is:

1. A sync signal detection circuit comprising:
a first circuit system configured to receive a sync phase signal formed by repeating a sequence of a non-modulated field, sync field, and address field, and to generate a gate signal corresponding to a position of the sync field according to the non-modulated field in the sync phase signal;
a second circuit system configured to receive the sync phase signal and to generate a sync signal indicating a head of the address field according to the sync field in the sync phase signal; and
a third circuit system configured to provide a sync output by passing the sync signal while the gate signal is generated.

2. A circuit according to claim 1, wherein the sync phase signal corresponds to a wobble modulated wave played back from an optical disc, and the first circuit system includes a wobble addition circuit configured to add adds a plurality of wobbles as one unit, a counter configured to count addition results of the wobble addition circuit, and a signal generation circuit configured to generate the gate signal when a count result of the counter reaches a value corresponding to the position of the sync field.

3. A circuit according to claim 1, wherein the sync field in the sync phase signal has a unique pattern, and the second circuit system includes a pattern detection circuit configured to detect the unique pattern, and a comparison/determination circuit configured to determine whether the pattern detected by the pattern detection circuit matches a predetermined sync pattern.

4. A circuit according to claim 1, further comprising:
an address detection circuit system configured to output an address head signal indicating the head of the address field in the sync phase signal according to the sync output from the third circuit system; and
a physical address holding circuit configured to hold and to output contents of the address field, which follows the address head signal, as information indicating a physical address of the address field.

5. A disc drive device comprising:
a spindle motor configured to rotate an optical disc on which a sync phase signal formed by repeating a sequence of a non-modulated field, sync field, and address field is recorded by wobble modulation;
an optical pickup configured to play back the sync phase signal from the optical disc rotated by the spindle motor;
a first circuit system configured to receive the sync phase signal played back by the optical pickup, and to generate a gate signal corresponding to a position of the sync field according to the non-modulated field in the sync phase signal;
a second circuit system configured to receive the sync phase signal and to generate a sync signal indicating a head of the address field according to the sync field in the sync phase signal; and
a third circuit system configured to provide a sync output by passing the sync signal while the gate signal is generated.

6. A device according to claim 5, wherein the sync phase signal corresponds to a wobble modulated wave played back from the optical disc, and the first circuit system includes a wobble addition circuit configured to add a plurality of wobbles as one unit, a counter configured to count addition results of the wobble addition circuit, and a signal generation circuit configured to generate the gate signal when a count result of the counter reaches a value corresponding to the position of the sync field.

7. A device according to claim 5, wherein the sync field in the sync phase signal has a unique pattern, and the second circuit system includes a pattern detection circuit configured to detect the unique pattern, and a comparison/determination circuit configured to determine whether the pattern detected by the pattern detection circuit matches a predetermined sync pattern.

8. A device according to claim 5, further comprising:
an address detection circuit system configured to output an address head signal indicating the head of the address field in the sync phase signal according to the sync output from the third circuit system; and
a physical address holding circuit configured to hold and to output contents of the address field, which follows the address head signal, as information indicating a physical address of the address field.

9. A signal processing method comprising:
generating, using a sync phase signal formed by repeating a sequence of a non-modulated field, sync field, and address field, a gate signal corresponding to a position of the sync field according to the non-modulated field in the sync phase signal;
generating, using the sync phase signal, a sync signal indicating a head of the address field according to the sync field in the sync phase signal; and
providing a sync output by passing the sync signal while the gate signal is generated.

10. A method according to claim 9, further comprising:
outputting an address head signal indicating the head of the address field in the sync phase signal according to the sync signal; and
holding and outputting contents of the address field, which follows the address head signal, as information indicating a physical address of the address field.
